(19) United States
(12) Patent Application Publication
(10) Pub. No.: US 2005/0136766 A1
(43) Pub. Date: Jun. 23, 2005

(54) Wet-or dry-use biodegradable collecting sheet

(76) Inventors: James J. Tanner, Winneconne, WI (US); Jason Lye, Atlanta, GA (US); Bernard Cohen, Duluth, GA (US)

Correspondence Address: Melanie I. Rauch;Pauley Petersen & Erickson, Suite 365, 2800 West Higgins Road, Hoffman Estates, IL, 60195, US

(21) Appl. No.: 10/738,959

(22) Filed: Dec. 17, 2003

(51) Int. Cl. D03D 15/00; D03D 11/00; B05D 3/00; B05D 3/12; B32B 5/08; D03D 25/00

(52) U.S. Cl. 442/181; 442/188; 442/205; 442/208; 442/209; 442/218; 442/220; 427/322; 427/355; 427/384

(57) ABSTRACT

A biodegradable, cellulose-based collecting sheet that can be used in either a wet state or a dry state. The collecting sheet may be a double recreped cellulose substrate reinforced with a binder, such as a latex binder. Alternatively, or in addition to the binder, the collecting sheet may be coated with a dielectric material and electret treated to establish a charge on the dielectric material. Additionally, the collecting sheet may be embossed to provide more interstices and greater surface area to enhance the pick-up ability of the collecting sheet. The invention further includes a method of forming such a collecting sheet.

### TECHNICAL FIELD OF THE INVENTION

This invention is directed to a collecting sheet.

### BACKGROUND OF THE INVENTION

Disposable cleaning sheets are often preferred over cloth sheets for the convenience and cleanliness of being able to start with a new sheet every time. Disposable cleaning sheets are available to cover a broad range of applications, from paper towels for cleaning up spills to thicker, more abrasive towels for scrubbing surfaces. Some cleaning sheets are designed to be used by hand while others can be attached to the end of a broomstick or mop handle. Some cleaning sheets are intended for dry use, such as dusting, while others are designed for use with aqueous cleaning solutions. In any case, a cleaning sheet must have an appropriate surface, an appropriate level of softness, and must be durable enough for its intended application.

Nonwoven webs are often used to make disposable cleaning sheets because nonwoven webs can be designed to provide sufficient durability and softness, rivaling the properties of cloth at a lower price. However, nonwoven webs made from polyolefins may be persistent in the environment. Paper products, even less expensive than nonwoven webs, are also often used to make cost-efficient disposable cleaning sheets. However, paper products that are durable are typically quite stiff, while soft paper products typically lack strength. This is because conventional paper products are strengthened by increasing interfiber bonds formed by hydrogen bonding and the increased interfiber bonds are associated with stiffness in paper products. Also, increased density for strengthening conventional paper products generally decreases the capacity to hold liquid or to collect dust or other particles due to decreased interstitial space in the fibrous web. In general, conventional paper products are not strong when wetted.

Some materials maintain an electrostatic charge, or can be electret-treated to maintain an electrostatic charge. Materials having an electrostatic charge can be used in a dry state to pick up dust bunnies and other types of dust particles. Such materials are typically expensive. In contrast, cellulosic materials, which are relatively inexpensive, when used alone do not usually maintain an electrostatic charge and cannot be electret-treated to maintain an electrostatic charge.

There is a need or desire for a low-cost collecting sheet that has particle collecting abilities as well as strength properties for either wet or dry cleaning. There is a further need or desire for a cleaning sheet that is biodegradable.

### SUMMARY OF THE INVENTION

In response to the discussed difficulties and problems encountered in the prior art, a new reinforced, biodegradable, cellulose-based collecting sheet has been discovered.

The present invention is directed to a collecting sheet including a cellulose-based substrate. The substrate may be reinforced with a binder, such as a latex binder. Alternatively, or in addition to the binder, the substrate may be coated with a dielectric material and subsequently electret treated to establish a charge on the dielectric material. Additionally, the collecting sheet may be embossed to provide added reinforcement and greater surface area.

The cellulose-based substrate may include a single-ply or multi-ply double recreped cellulose material. As a result of creping, the cellulose-based substrate may have a combination of shorter fibers and longer fibers oriented in a Z direction across a thickness of the collecting sheet.

The collecting sheet can be formed by creping one surface of the cellulose-based substrate, and then recreping the opposite surface of the cellulose-based substrate. The binder material may be applied to the cellulose-based substrate either before or after the recreping step. Similarly, the dielectric material may be applied to the cellulose-based substrate either before or after the recreping step. After the dielectric material has been applied to the cellulose-based substrate, the collecting sheet can be electret treated to establish a charge on the dielectric material.

The reinforced cellulose-based substrate provides considerable strength as well as desirable surface properties for the collecting sheet. Furthermore, the collecting sheet has ample interstitial space for collecting dust, and can be used in either a wet state or a dry state for cleaning a variety of surfaces. In addition, the collecting sheet of the invention may be used to clean by hand or may be attached to the end of a mop handle for cleaning floors. As mentioned, the collecting sheet may be embossed.

The cellulose-based material used to make the collecting sheet of the invention is significantly less expensive than polyolefin materials typically used to make nonwoven cleaning sheets. Furthermore, unlike polyolefin materials, cellulose-based material is biodegradable.

With the foregoing in mind, it is a feature and advantage of the invention to provide a low-cost collecting sheet that has dust collecting abilities as well as strength properties for either wet or dry cleaning. It is another feature and advantage of the invention to provide a biodegradable collecting sheet.

### BRIEF DESCRIPTION OF THE DRAWINGS

FIG. 1 illustrates an enlarged side view of one embodiment of a cellulose-based substrate of the invention.

FIG. 2 illustrates a plan view of one example of an embossment pattern on a collecting sheet of the invention.

FIG. 3 illustrates a perspective view of a collecting sheet of the invention.

FIG. 4 illustrates a schematic view of a collecting sheet of the invention attached to a mop handle.

### DEFINITIONS

Within the context of this specification, each term or phrase below will include the following meaning or meanings.

“Attached” refers to the joining, adhering, connecting, bonding, or the like, of at least two elements. Two elements will be considered to be attached together when they are attached directly to one another or indirectly to one another, such as when each is directly attached to intermediate elements.

“Cellulose-based” refers to any material having cellulose as a major constituent, and specifically, comprising at least 75% by weight cellulose or a cellulose derivative. Thus, the term includes cotton, typical wood pulps, cellulose acetate, rayon, thermomechanical wood pulp, chemical wood pulp, debonded chemical wood pulp, milkweed floss, and the like.

“Dielectric material” refers to any material, such as a polymer, which is an electrical insulator or in which an electric field can be sustained with a minimum dissipation of power. A solid material is a dielectric if its valence band is full and is separated from the conduction band by at least 3 eV. This definition is adopted from the McGraw-Hill Encyclopedia of Science & Technology, 7th Edition, Copyright 1992.

“Electret treatment” or “electreting” refers to any process which places a charge in and/or on a dielectric material. One exemplary process for placing a charge on a dielectric material involves the application of a DC corona discharge to the material. An exemplary conventional method of this type is described in detail in U.S. Pat. No. 5,401,446 issued to Tsai et al., hereby incorporated by reference.

“Machine direction” as applied to a web, refers to the direction on the web that was parallel to the direction of travel of the web as it left the extrusion or forming apparatus, or as it travels through a treatment process. If the web passed between nip rollers or chill rollers, for instance, the machine direction is the direction on the web that was parallel to the surface movement of the rollers when in contact with the web. “Cross direction” refers to the direction perpendicular to the machine direction within the plane of the web. “Z direction” refers to the direction of the web perpendicular to both the machine direction and the cross direction, namely through the thickness of the web.

“Meltblown fiber” refers to fibers formed by extruding a molten thermoplastic material through a plurality of fine, usually circular, die capillaries as molten threads or filaments into converging high velocity gas (e.g., air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed for example, in U.S. Pat. No. 3,849,241 to Butin et al. Meltblown fibers are microfibers which may be continuous or discontinuous, are generally smaller than about 0.6 denier, and are generally self bonding when deposited onto a collecting surface.

“Nonwoven” and “nonwoven web” refer to materials and webs of material having a structure of individual fibers or filaments which are interlaid, but not in an identifiable manner as in a knitted fabric. Nonwoven fabrics or webs have been formed from many processes such as, for example, meltblowing processes, spunbonding processes, air laying processes, and bonded carded web processes. The basis weight of nonwoven fabrics is usually expressed in ounces of material per square yard (osy) or grams per square meter (gsm) and the fiber diameters are usually expressed in microns. (Note that to convert from osy to gsm, multiply osy by 33.91.)

“Polymers” include, but are not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the material. These configurations include, but are not limited to isotactic, syndiotactic and atactic symmetries. “Spunbond fiber” refers to small diameter fibers which are formed by extruding molten thermoplastic material as filaments from a plurality of fine capillaries of a spinnerette having a circular or other configuration, with the diameter of the extruded filaments then being rapidly reduced as taught, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartmann, U.S. Pat. No. 3,502,538 to Petersen, and U.S. Pat. No. 3,542,615 to Dobo et al., each of which is incorporated herein in its entirety by reference. Spunbond fibers are quenched and generally not tacky when they are deposited onto a collecting surface. Spunbond fibers are generally continuous and often have average deniers larger than about 0.3, more particularly, between about 0.6 and 10.

“Thermoplastic” describes a material that softens and flows when exposed to heat and which substantially returns to a non-softened condition when cooled to room temperature.

These terms may be defined with additional language in the remaining portions of the specification.

### DETAILED DESCRIPTION

The present invention is directed to a reinforced, biodegradable, cellulose-based collecting sheet. The sheet is reinforced to prevent tearing when rubbed on a hard surface. The reinforcement also enables the sheet to be used in either a wet state or a dry state.

The collecting sheet includes a cellulose-based substrate. Cellulose is a relatively inexpensive material compared to polyolefins from which nonwoven webs are often made. Furthermore, the cellulose-based cleaning products of the invention are at least as durable and fuinctional as comparable nonwoven products.

Another benefit of cellulose-based materials is that, unlike polyolefins, cellulose is biodegradable. More particularly, cellulose can be microbially decomposed. A standard test for aerobic biodegradability is ASTM D5338-98. The cellulose-based collecting sheet of the invention may also be compostable. Compostability is a more stringent standard than biodegradability. Compostability requires 1) biodegradability; 2) disintegratability to 2 mm or less in a short time frame; and 3) no eco-toxicity. An ASTM standard D6400-99 has been established for compostable plastics (basically for a single polymer 60% to carbon dioxide and water within 6 months; if multipolymers, i.e., more than 0.5%, then 90% for each one).

The collecting sheet need not be 100% biodegradable, but suitably is composed primarily of biodegradable materials in order to be considered biodegradable. In certain embodiments, non-biodegradable material may account for up to about 25% by weight of the collecting sheet. Suitably, at least 75%, or at least 80%, or at least 90% by weight of the material of the collecting sheet is biodegradable.

Cellulose fibers beneficially have fibrils which are not present in nonwoven fibers. These fibrils can be caused to extend in a Z direction, thereby providing greater particle pick-up, as explained below. The cellulose-based substrate suitably includes at least 75% by weight cellulose or a cellulose derivative, or between about 80% and about 99% by weight cellulose or a cellulose derivative.

The cellulose-based substrate may include a double recreped cellulose material, as described in U.S. Pat. No. 5,674,590 issued to Anderson et al., U.S. Pat. No. 4,158,594 issued to Becker et al., and U.S. Pat. No. 3,879,257 issued to Gentile et al., each of which is herein incorporated by reference. More specifically, a double recreped cellulose material includes both short fibers and long fibers in a predetermined range of ratios. For example, the short fibers may range from approximately 70% to approximately 95% of the total weight of the collecting sheet, while the long fibers may range from approximately 5%. to approximately 30% of the total weight of the collecting sheet. The short fibers may include northern softwood kraft (NSWK) and/or softwood chemi-thermo-mechanical pulp (CTMP). Both NSWK and CTMP are less than 3 mm in length. CTMP has a wet stiff property for stabilizing the collecting sheet when the collecting sheet holds liquid. The long fibers on the other hand, generally can be natural redwood (RW), cedar, and/or other natural fibers, or synthetic fibers. Some examples of the synthetic fibers include polyester (PE), rayon, polyolefin, and acrylic fibers, and they come in a variety of predetermined widths. Each of these long fibers is generally from approximately 5 mm to approximately 9 mm in length.

The double recreped cellulose material has a web structure including first fibers, either the short fibers or the long fibers, oriented substantially in a predetermined Z direction across a thickness of the web structure, and a portion of the second fibers, the second fibers being the other of the short fibers or the long fibers, being in contact with the first fibers and caused to be oriented substantially in the predetermined Z direction by the first fibers, thereby creating a substantially non-laminar-like structure. The Z direction is indicated by arrow 32 in FIG. 1. The fibers and fibrils extending in the Z direction provide greater surface area on the sheet which results in greater pick-up capabilities.

Referring to FIG. 1, a side view or cross-sectional view of a suitable double recreped stratified web structure serving as a cellulose-based substrate 20 is diagrammatically illustrated. Outer regions 22 generally contain short fibers 24 which are oriented in random directions. A middle region 26 is located between the two outer regions 22 and primarily contains short fibers 28 as well as a large portion of long fibers 30. These long fibers may be either synthetic or natural. Examples of long synthetic fibers include polyester and rayon while examples of long natural fibers include redwood kraft and cedar pulp. These short and long fibers in the middle region are substantially oriented in a vertical or Z direction across the thickness of the web structure. As the web structure is creped, the middle region fibers that are relatively mobile due to their low bonding property are “popped up” or “stood up” in the Z direction, partially due to their entanglement with other long fibers that are anchored by a printed latex bonding agent.

Another type of suitable cellulose-based substrate is a creped cellulose base sheet. Creping of cellulose structures is known in the art and is taught, for example, in the references that teach the double recreped cellulose materials mentioned above. Creping improves certain properties of the web structure. More specifically, the creping action causes unbonded or lightly bonded fibers in the web to puff up and spread apart, thus imparting softness, reduced fiber-to-fiber hydrogen bonding, and bulk characteristics in the web structure. Consequently, the creped cellulose base sheet has increased surface area with ridges in which to collect dirt and hair. The process of double recreping involves creping one surface of a substrate, and subsequently recreping the opposite surface of the substrate, thereby creating much more surface area and ridges than a single creping process.

The cellulose-based substrate may include a cellulose base sheet with fibers entangled therein, such as cotton fibers, rayon fibers, wood pulp fibers, and/or thermoplastic polymer fibers. In one embodiment, the cellulose-based substrate may include nonwoven fibers, such as meltblown fibers or spunbond fibers, entangled with cellulose fibers. In yet another embodiment, the cellulose-based substrate may include hydroentangled nonwoven fibers, and/or hydroentangled cellulose pulp. Hydroentanglement causes long polymer fibers to extend in a Z direction from the sheet in a manner similar to double recreped material.

In still another embodiment, the cellulose-based substrate may include a high pulp content nonwoven web, such as HYDROKNIT®, available from Kimberly-Clark Corporation, which is formed from approximately 80% wood fiber cellulose and 20% polypropylene continuous fiber, such as 0.3 ounces per square yard (osy) nonwoven fabric and paper pulp.

Additionally, the cellulose-based substrate may be single-ply or multi-ply. Multiple plies are particularly suitable for collecting sheets intended for attachment to mops. The substrate, depending upon the intended application of the collecting sheet, suitably has a basis weight between about 0.006 and about 0.025 grams per square centimeter.

The cellulose-based substrate may be reinforced in one or more ways. For example, the substrate may be reinforced with a binder or scrim. In any case, the collecting sheet is not bonded with hydrogen bonds, as paper products are typically bonded. One type of suitable binder is a latex binder. More specific examples of suitable binders include vinyl acetate or acrylate homopolymer or copolymer cross-linking latex rubber emulsions. Suitably, the cellulose-based substrate may include between about 3% and about 20% by weight latex binder. The binder provides reinforcement to the cellulose-based substrate, rendering the collecting sheet durable enough for use in a wet state. When the cellulose-based substrate is a double recreped cellulose material, the binder can be applied to the cellulose-based substrate at various times during the double recreping process, such as between the creping and the recreping steps, or after the recreping step.

The binder material for the current invention generally has at least two important functions. First, the binder material interconnects the fibers in the web structure. The interconnected fibers provide additional strength to the web structure. In addition to interconnecting the fibers, the binder material, located on the surface, adheres to a creping drum as the web undergoes creping in a creping, or recreping, process. To satisfy these functions, other suitable binder materials include butadiene acrylonitrile type, other natural or synthetic rubber lattices, or dispersions thereof with elastomeric properties such as butadiene-styrene, neoprene, polyvinyl chloride, vinyl copolymers, nylon or vinyl ethylene terpolymer.

In general, two classes of binder materials can be considered: thermoplastic solid materials (particles or fibers), and liquids (for example, resins or solutions) that can be cured or set by application of heat or other energy sources to provide dry, water-resistant bonds between fibers. The cellulose-based substrate may include between about 3% and about 20% by weight binder material.

For solid binder materials, any known thermoplastic material can be used as a binder, provided that the material can be fused at a temperature that does not destroy or render unsuitable the cellulose-based substrate itself. A thermoplastic binder upon activation by heat becomes soft but reverts to its normal solid state upon cooling. Representative of such thermoplastic binder materials are polypropylenes, polyethylenes, polycarbonates, polyvinyl chloride, polyesters, polystyrenes, acrylics and the like. The binder material may be hydrophobic or hydrophilic. Hydrophilic fibers can be inherently hydrophilic or can be a synthetic hydrophobic fiber that has been treated with a hydrophilic coating or treatment. Examples of hydrophilic binder fibers are given in U.S. Pat. No. 5,849,000 issued to Anjur et al., herein incorporated by reference.

The binder material can be monocomponent fibers or bicomponent polymer fibers such as sheath/core fibers or side-by-side bicomponent fibers, having a first component with a lower melting point than the second component, such that upon heating to about the melting point of the first component, the first component can fuse and bond to nearby cellulosic fibers while the second component can maintain the integrity of the binder fiber. Examples include DANAKLON bicomponent fibers available from Hercules, Inc. (Wilmington, Del.); or PET (poly(ethylene terephthalate)) core fibers and an activated co-polyethylene sheath, such as CELBOND fibers produced by KoSA Inc. (formerly Trevira Inc. and formerly Hoechst-Celanese), Salisbury, N.C., under the designation T-255 and T-256. Other useful binder fibers include copolyester fibers or materials produced by ES FiberVisions Inc. In addition to sheath/core fibers, components of a binder fiber having a plurality of polymers may be arranged in an eccentric sheath/core arrangement, a side-by-side arrangement, a pie arrangement or an “islands-in-the-sea” arrangement, or in a blend. Conjugate fibers are taught in U.S. Pat. No. 5,108,820 issued to Kaneko et al., U.S. Pat. No. 5,336,552 issued to Strack et al., and U.S. Pat. No. 5,382,400 issued to Pike et al. For two-component fibers, the polymers may be present in ratios of 75/25, 50/50, 25/75 or any other desired ratios. The fibers may also have shapes such as those described in U.S. Pat. Nos., 5,277,976; 5,069,970; and 5,057,368; each hereby incorporated by reference in their entirety, which describe fibers with unconventional shapes.

Monocomponent fibers can include, by way of example, polyethylene microfibers marketed as PULPEX fibers by Hercules, Inc. (Wilmington, Del.) or Eastman's KODEL 410 binder fiber. This fiber requires a minimum temperature of about 132° Celsius for good bonding. CoPET B (co-polyethylene terephthalate) from Eastman Chemical Company is another commercially available binder material with an activation temperature of about 110° Celsius or higher. (This material can also be used as a sheath. For example, a useful bicomponent fiber is a coextruded sheath/core bicomponent with 35% CoPET B and a 65% polyethylene terephthalate core.)

Fibrous binder material can have a weight-averaged fiber length of about 8 centimeters (cm) or less, specifically from about 0.2 cm to 5 cm, more specifically from 0.3 cm to 3 cm, more specifically still from 0.3 cm to 2 cm, and most specifically from 0.4 cm to 1 cm.

The binder material can also be a microwave-sensitive material having a high dielectric loss factor (for example, from about 1 to 1,000 measured at a frequency of 1 GHz) such that the binder material is heated more than any cellulosic fibers in the substrate when microwave energy is applied. (Cellulose can have a loss factor on the order of about 0.06 at 1 GHz.) Exemplary materials include polyamide or polyvinyl methyl based hot melt adhesives and other thermoplastics known in the art. Polyether block amides, polyvinyl chloride (PVC), and related compounds also have high loss factors. The material can have a loss factor much greater than that of cellulose.

Binder materials can also be applied as liquid resins, slurries, colloidal suspensions, or solutions that become rigid or crosslinked upon application of energy (for example, microwave energy, heat, ultraviolet radiation, and the like).

Various types of thermosetting binders are known to the art such as amino resins, epoxides, silicones, and the like, as well as elastomeric latex emulsions. Representative thermosetting binder materials which are adapted for application in the form of a liquid dispersion include copolymers of ethylene and acrylic acid, vinyl acetate-ethylene copolymers, acrylonitrile-butadiene copolymers, vinylchloride polymers, vinylidene chloride polymers, curable acrylic latex compositions, and the like.

Water-soluble, non-colloidal, cationic, thermosetting binders suitable for use with cellulosic fibers are disclosed in U.S. Pat. No. 4,617,124 issued to Pall et al., herein incorporated by reference, where epoxide-based versions are said to be preferred, including both polyamido/polyaminoepichlorohydrin resins and polyamine-epichlorohydrin resins, such as KYMENE 557 and the POLYCUP series of resins manufactured by Hercules Incorporated (Wilmington, Del.). Related materials can be prepared by reacting epichlorohydrin with condensation products of polyalkylene polyamides and ethylene dichloride. Compositions of this type are disclosed in U.S. Pat. No. 3,855,158 and are exemplified by SANTO-RES 31, a product of Monsanto Inc. Another form of this particular type of binder resin is prepared by the reaction of epichlorohydrin with polydiallyl methyl amine to produce an epoxide functional quaternary ammonium resin. Compositions of this kind are disclosed in U.S. Pat. No. 3,700,623 and are exemplified by Resin R4308, a product of Hercules Incorporated. The disclosures of U.S. Pat. Nos. 3,855,158 and 3,700,623 are incorporated herein by reference.

The collecting sheet of the invention can be used for wet applications as well as dry applications. The collecting sheet may include various treatments or coatings depending on the intended use.

For dry use, the cellulose-based substrate may be coated with a dielectric material and electret treated to establish a charge on the dielectric material, thus making the sheet more effective at picking up dust and dirt. The dielectric material can be any material that is dielectric in nature, such as ethylene acrylic acid, copolymers of ethylene acrylic acid, polyolefins, polyolefin copolymers, nylons, polyesters, and/or certain waxes. One type of coating that is particularly effective is an ethylene acrylic acid dispersion. Examples of commercially available ethylene. acrylic acid dispersions include MICHEM Prime 4983R and MICHEM Prime 4990R, both available from Michelman, Inc., of Cincinnati, Ohio. A suitable electret treatment process is described in U.S. Pat. No. 5,964,926 issued to Cohen, hereby incorporated by reference. The electret-treated collecting sheet is capable of retaining a charge for an extended period of time. Additionally, the electret treatment creates exceptional softness or fuzziness.

The coating of dielectric material is suitably as thin as practical in order to effect the most cost-effective product. For example, the coating of dielectric material may be less than about 5 microns in thickness, or less than about 2 microns in thickness, or even less than 0.5 micron in thickness. Suitably, the collecting sheet includes less than about 15%, or less than about 10%, dielectric material by weight of the collecting sheet in a dry state. The coating step may be carried out by conventional emulsion coating the dielectric material onto the cellulose-based substrate. Conventional spraying and dip-and-squeezing techniques may also be used. When the cellulose-based substrate is a double recreped cellulose material, the dielectric material can be applied to the cellulose-based substrate at various times during the double recreping process, such as between the creping and the recreping steps, or after the recreping step. The electret treatment may include the application of a DC corona discharge to the coated collecting sheet. In another dry-use embodiment of the invention, a tackifier or wax can be added to the sheet to aid in picking up particles such as breadcrumbs.

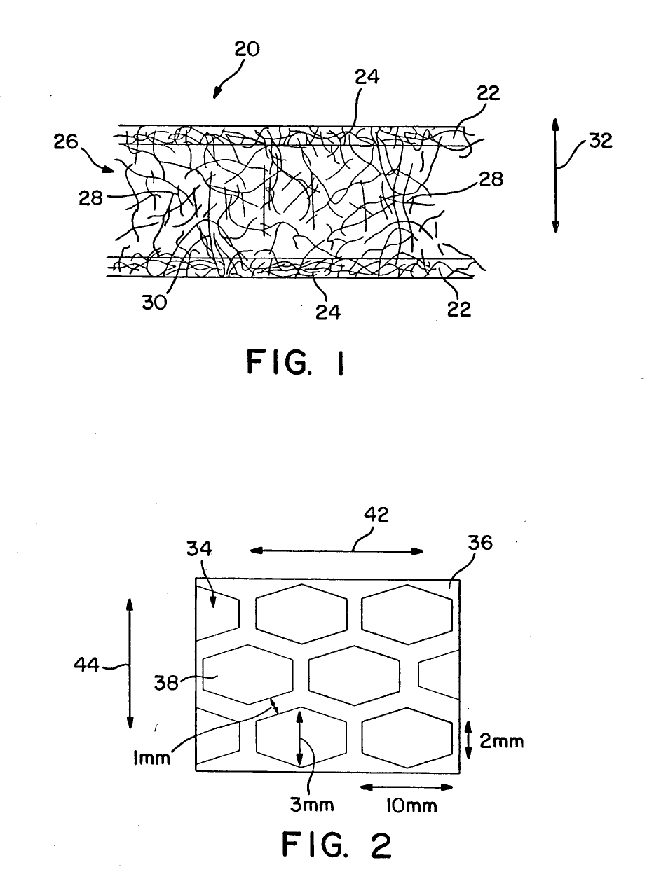

Another form of reinforcement that may be applied to the cellulose-based substrate, either in addition to the binder material or in place of the binder material, is embossing. In addition to providing reinforcement, the substrate may be embossed with any of a variety of patterns to aid in the pick-up of dirt or debris, or simply for aesthetics. An example of one suitable embossing pattern 34 is shown in FIG. 2. More particularly, in FIG. 2 the collecting sheet 36 is embossed with elongated polygons 38, similar to a brick work pattern. Suitably, the polygons are elongated in a machine direction, with the machine direction indicated by arrow 42 in FIG. 2. A cross direction of the sheet is indicated by arrow 44 in FIG. 2. The interior portions of the polygons 38 may form depressions in the collecting sheet 36. These depressions act as pockets that are particularly adept at picking up particles. The polygons 38, or other embossed shapes, may vary in size as well as shape across the surface of the collecting sheet 36. The embossed shapes need not be closed shapes, but instead may be wavy lines, or a combination of closed shapes and wavy or non-straight lines. Embossed wavy lines are particularly helpful in entangling hair, thus enabling the collecting sheet to pick up hair along with other particles.

Embossing forms interstices and increases the surface area of the collecting sheet, thereby improving the pick-up ability of the collecting sheet. Additionally, embossing softens the collecting sheet, which is particularly useful in counteracting any stiffness resulting from the post-treatment application of a binder or coating. In particular, embossing affects the density of the collecting sheet such that the density at the surface of the sheet is higher than the density in the center or core of the sheet, which is just the opposite of a non-embossed double-recreped material. Density of the sheet is related to porosity, which affects the sheet's ability to collect materials. Density at various locations within the sheet can be measured using a scanning electron microscope. The examples below demonstrate the effectiveness of embossing the collecting sheet.

For wet use, a variety of cleaning compositions, such as soaps, detergents, solvents, and the like, can be added to the collecting sheet. The sheet can be pre-moistened or can be wet in use using a delivery device. Pre-moistened sheets suitably contain a liquid which can be a solution including components that provide the desired wetness as well as any other desirable properties. For example, the components may include water, emollients, surfactants, preservatives, chelating agents, pH buffers or combinations thereof The amount of liquid contained within each sheet may vary depending upon the composition, size, and basis weight of the sheet, as well as the type of liquid applied. The collecting sheet of the invention has greater wet strength compared to non-reinforced cellulose materials which are typically held together with hydrogen bonds. In particular, the adhesive bonding provided in the double recreped cellulose materials gives the materials exceptional strength in the wet state as well as in the dry state.

The collecting sheet may be compressed to a relatively thin form, the thickness of which is dependent upon the content of the collecting sheet. Compression of the collecting sheet is particularly suitable for high-pulp-content collecting sheets. When the compressed collecting sheet is used in wet applications, the thickness of the collecting sheet may increase at least two-fold, or multi-fold, its compressed thickness as it absorbs water or other liquid. The perceptible growth of a cleaning product is often viewed by consumers as an indication of an effective product.

The collecting sheet, wet or dry, can be rendered antimicrobial by using the technology described in U.S. Pat. No. 4,975,217 issued to Brown-Skrobot et al., hereby incorporated by reference. More particularly, the cellulose-based substrate may be treated with a germicidal composition. The germicidal composition may include an alkyl sulfonate salt and an organic acid such as malic acid, citric acid, and mixtures thereof. The germicidal composition may further include an alcohol.

It is important to keep in mind that one must exercise judgment with any coating or binder to use the most appropriate amount to meet competing needs. More would be applied if only tensile strength of the base sheet were of utmost importance. Conversely, less would be applied if only softness, drape and flexibility were of utmost importance. Enough should be applied to a sheet to allow the sheet to permanently hold an electrostatic charge, but an excessive amount should be avoided in order to avoid hindering the fuzzy fibers or fibrils projecting out of the sheet in the Z direction.

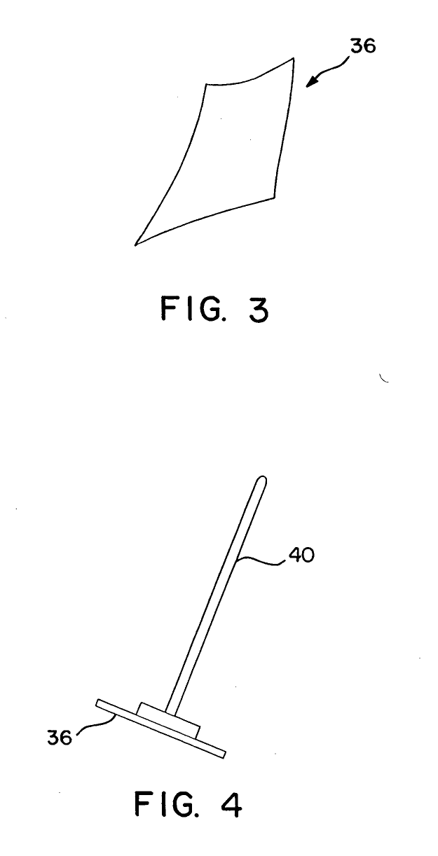

The collecting sheet 36 of the invention may be used to clean by hand in sheet form, as shown in FIG. 3, or as a mitt, or may be attached to the end of a mop handle, broomstick, or other elongated shaft 40, as shown in FIG. 4, for cleaning floors or hard-to-reach surfaces. Any suitable attachment device can be used for attaching the collecting sheet 36 to the shaft 40, such as mechanical clamps or fasteners, adhesives, and the like, for example. The basis weight of the collecting sheet may necessarily be increased, in some instances, for attachment to the shaft. The basis weight can be increased by using multiple layers of cellulose-based materials. Additionally, the collecting sheet may be in shredded form, thereby increasing the amount of surface area of the collecting sheet that comes into direct contact with the surface being cleaned. In one embodiment, hook component material of a hook-and-loop fastener can be affixed to the shaft such that the collecting sheet can be releasably attached to the hook component material in the same manner that loop component material is attached to hook component material. Low basis weight sheets may. be particularly suitable for use when attaching the sheets to hook component materials. Hydroentangled polyolefins, in particular, can add strength to the cellulose-based based substrate as well as providing a way of electrostatically attaching the collecting sheet to the shaft.

In one embodiment, the collecting sheet can first be attached to a flat piece of reinforcing material, such as plastic, wood, or cardboard. This embodiment is particularly useful for cleaning flat surfaces. The collecting sheet attached to the reinforcing material can be used to clean by hand, and/or the reinforcing material can be attached to the end of an elongated shaft, as shown in FIG. 4.

As described herein, the reinforced, biodegradable, cellulose-based collecting sheet of the invention provides considerable strength for use in either a wet or dry state and can be used to clean a variety of surfaces. Furthermore, the collecting sheet, with fibers or fibrils extending in the Z direction, has ample interstitial space and surface area for collecting dust and other particles. In addition, the collecting sheet of the invention may be used to clean by hand or may be attached to the end of a mop handle for cleaning floors and other hard-to-reach areas.

### EXAMPLE 1

In this example, samples of unprinted KLEENEX® VIVA® paper towel material, commercially available from Kimberly-Clark Corporation of Neenah, Wisconsin, made of double recreped cellulose material strengthened with 2-4% latex were used. Each sheet of paper towel had a machine direction length of 10.375 inches (263 millimeters) and a cross direction width of 11 inches (280 millimeters), with an area of 114.125 square inches (736.4 square centimeters), and a mass of 4.917 grams. Consequently, each sheet of paper towel had a basis weight of 0.0431 grams per square inch (0.00668 grams per square centimeter). The samples were embossed on a hydraulic press unit model #3925, available from Carver Inc. of Wabash, Indiana. Samples were embossed at room temperature.

Sample 1 was embossed under 10,000 pounds pressure for 1 minute, with a wire side of the press facing downward to produce embossing on a top surface of the sample and with greaseproof paper placed underneath the sample. The pattern embossed on Sample 1 is shown in FIG. 2, with the polygons having dimensions as shown in FIG. 2.

Sample 2 was embossed in the same manner as Sample 1, but under slightly more than 15,000 pounds of pressure.

Tear strength of both samples were compared to the tear strength of non-embossed KLEENEX® VIVA® paper towel and it was determined that the compression of both samples made the paper towel stronger than non-embossed KLEENEX® VIVA® paper towel. Furthermore, embossing improved the pick-up ability of the samples by forming interstices and increasing the surface area. As known in the art, embossing provides recessed areas or cavities to assist in picking up and storing larger particles such as hair and crumbs.

### EXAMPLE 2

In this example, samples were made using multiple sheets of unprinted KLEENEX® VIVA® paper towel material, commercially available from Kimberly-Clark Corporation of Neenah, Wisconsin, made of double recreped cellulose material strengthened with 2-4% latex were used. Each individual sheet of paper towel material had a machine direction length of 10.375 inches (263 millimeters) and a cross direction width of 11 inches (280 millimeters), with an area of 114.125 square inches (736.4 square centimeters), and a mass of 4.917 grams. Consequently, each sheet of paper towel had a basis weight of 0.0431 grams per square inch (0.00668 grams per square centimeter). Sheets were glued together to form thicker sheets before embossing in the same manner as Sample 2 in Example 1.

Sample 1 included 3 sheets of KLEENEX® VIVA® paper towel glued together using 3M Super 77 spray adhesive, available from 3M. One side of each of two sheets was sprayed with the adhesive for five seconds each, from a distance of approximately 10-12 inches. After applying the adhesive, the third sheet was positioned between the adhesive-bearing sides of the sprayed sheets, and gentle pressure was applied to ensure contact between the sheets. The sample had a basis weight, not including the adhesive, of 0.129 grams per square inch (0.020 grams per square centimeter). The sample was embossed with small irregular polygons under 15000 pounds (˜7 metric tons). The resulting polygonal-shaped depressions were deeper than in Sample 2 in Example 1.

Sample 2 included 2 sheets of KLEENEX® VIVA® paper towel glued together by spraying one side of one sheet with 3M Super 77 spray adhesive for five seconds from a distance of approximately 10-12 inches, and placing the second sheet on top of the adhesive-bearing side of the sprayed sheet and gently applying pressure to ensure contact between the sheets. The sample had a basis weight, not including the adhesive, of 0.0862 grams per square inch (0.0134 grams per square centimeter). The sample was embossed with small irregular polygons under 15000 pounds (˜7 metric tons). The resulting polygonal-shaped depressions were deeper than in Sample 2 in Example 1, but did not look as defined or feel as soft as the 3-ply Sample I in this example.

### EXAMPLE 3

In this example, Sample I from Example I and Sample 1 from Example 2 were tested in their ability to pick up breadcrumbs. Each sample was weighed before the testing began. Between 0.22 and 0.27 grams of PROGRESSO® plain breadcrumbs, available from General Mills of Minneapolis, Minnesota, were spread out on linoleum floor tile in a tray having dimensions of 18 inches (46 cm) by 24 inches (61 cm). The breadcrumbs were distributed by gently blowing on them. Each sample was attached to the end of a mop by poking the edges of the cellulose-based collecting sheet into retaining grips located on the upper side of the mop head with a rough or embossed surface of the sample positioned to contact the flooring. The mop was then pushed once around the tray without lifting up the mop. After making one circuit around the tray, the mop was lifted by the handle and set back down on the tray and pushed around one more time. Each sample was weighed a second time to determine the weight of the sample plus crumbs. The weight of the sample alone was subtracted from this final weight to determine the amount of crumbs picked up. Results are shown in Table 1.

TABLE 1
Results of Breadcrumb Pick-Up Test

| | Cloth | Crumbs | Cloth + Crumbs | Difference | Percentage |
|---|---|---|---|---|---|
| Sample | (g) | (g) | (g) | (g) | Pick-Up |
| Sample1 | 4.93 | 0.27 | 4.99 | 0.06 | 22% |
| from | | | | | |
| Example1 | | | | | |
| Sample 1 | 15.31 | 0.25 | 15.35 | 0.04 | 16% |
| from | | | | | |
| Example 2 | | | | | |

Sample 1 from Example 1 picked up a greater percentage of the breadcrumbs, however it was discovered that the single-ply collecting sheet was prone to tearing when a finger was used to poke the collecting sheet into the mop head retaining grips. For sheets attached to mops, a 3-ply sheet is much less likely to be punctured during attachment.

Following the breadcrumb pick-up test, the samples were shaken off and used to pick up tumble dryer lint. The lint included a mixture of cotton and polyester fibers collected from an electric dryer. An 18 mesh sieve was used to separate the fibers by rubbing the lint against the holes of the sieve in a grater fashion, thereby grating the lint onto the surface from which the lint was collected. The collecting sheet samples successfully picked up 100% of the dryer lint.

### EXAMPLE 4

In this example, samples of unprinted KLEENEX® VIVA® paper towel material, commercially available from Kimberly-Clark Corporation of Neenah, Wisconsin, made of double recreped cellulose material strengthened with 2-4% latex were used. Each sheet of paper towel had a machine direction length of 10.375 inches (263 millimeters) and a cross direction width of 11 inches (280 millimeters), with an area of 114.125 square inches (736.4 square centimeters), and a mass of 4.917 grams. Consequently, each sheet of paper towel had a basis weight of 0.0431 grams per square inch (0.00668 grams per square centimeter). Sheets were coated with MICHEM Prime 4983R using a purpose built spray system. The spray system utilized a pressurized spray nozzle to spray fluids onto horizontal sheets of material. The sheets of material were supported by a wire mesh screen belt which was driven at a controlled speed to produce an even coating on. the samples. A vacuum was applied beneath the sample, through the wire screen in order to assist penetration of the coating into the sheet. Sheets were coated at 20. feet per minute and 30 feet per minute to give wet coating weight add-ons of 20.5% and 14.7% respectively. The samples were dried in an oven at 110 degrees Celsius to constant weight. As MICHEM Prime 4983R contains 25% non-volatiles, the dry add-on was 5.125% and 3.675% respectively. After drying, the samples were electret treated in the manner described in U.S. Pat. No. 5,401,446 issued to Tsai et al.

It will be appreciated that details of the foregoing embodiments, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention, which is defined in the following claims and all equivalents thereto. Further, it is recognized that many embodiments may be conceived that do not achieve all of the advantages of some embodiments, yet the absence of a particular advantage shall not be construed to necessarily mean that such an embodiment is outside the scope of the present invention.

1. A collecting sheet comprising:
a double recreped cellulose substrate reinforced with a binder and at least partially coated with a dielectric material.

2. The collecting sheet of claim 1, wherein the collecting sheet is biodegradable.

3. The collecting sheet of claim 1, wherein the collecting sheet has been electret treated to establish a charge on the dielectric material.

4. The collecting sheet of claim 1, wherein the double recreped cellulose substrate comprises a cellulose base sheet with at least one of the group consisting of cotton fibers, thermoplastic polymer fibers, rayon fibers, wood pulp fibers, nonwoven fibers, and hydroentangled cellulose pulp, entangled within the cellulose base sheet.

5. The collecting sheet of claim 1, wherein the substrate comprises multiple plies.

6. The collecting sheet of claim 1, wherein the binder comprises a latex binder.

7. The collecting sheet of claim 1, wherein the dielectric material comprises at least one of the group consisting of ethylene acrylic acid, copolymers of ethylene acrylic acid, polyolefins, polyolefin copolymers, nylons, polyesters, waxes, and combinations thereof.

8. The collecting sheet of claim 1, wherein the collecting sheet is embossed.

9. The collecting sheet of claim 1, further comprising a coating on the cellulose-based substrate, wherein the coating is selected from the group consisting of a tackifier, a wax, a cleaning composition, a wetting composition, a germicidal composition, and combinations thereof.

10. A collecting sheet comprising:
first fibers oriented substantially in a Z direction across a thickness of the collecting sheet, the first fibers having a weight ranging from approximately 5% to approximately 30% of the total collecting sheet; and
second fibers shorter than the first fibers and having a weight ranging from approximately 70% to approximately 95% of the total weight of the collecting sheet, some of the second fibers being in contact with the first fibers and caused to be oriented substantially in the Z direction by the first fibers;
wherein the collecting sheet is at least partially coated with a dielectric material..

11. The collecting sheet of claim 10, wherein the first fibers comprise at least one of the group consisting of redwood fibers, cedar fibers, polyester fibers, rayon fibers, acrylic fibers, polyolefin fibers, and combinations thereof.

12. The collecting sheet of claim 10, wherein the second fibers comprise at least one of the group consisting of northern softwood kraft fibers, softwood chemi-thermo-mechanical pulp, and combinations thereof.

13. The collecting sheet of claim 10, further comprising a latex binder reinforcing the first and second fibers.

14. The collecting sheet of claim 10, wherein the dielectric material comprises at least one of the group consisting of ethylene acrylic acid, copolymers of ethylene acrylic acid, polyolefins, polyolefin copolymers, nylons, polyesters, waxes, and combinations thereof.

15. The collecting sheet of claim 10, wherein the collecting sheet is embossed.

16. The collecting sheet of claim 10, further comprising a coating on the cellulose-based substrate, wherein the coating is selected from the group consisting of a tackifier, a wax, a cleaning composition, a wetting composition, a germicidal composition, and combinations thereof.

17. A method of forming a collecting sheet, comprising the steps of:
providing a cellulose-based substrate having a first surface and a second surface opposite the first surface;
creping the cellulose-based substrate from the first surface;
recreping the cellulose-based substrate from the second surface; and
at least partially coating the cellulose-based substrate with a dielectric material.

18. The method of claim 17, further comprising the step of electret-treating the cellulose-based substrate to establish a charge on the dielectric material.

19. The method of claim 17, comprising the step of coating the cellulose-based substrate with the dielectric material subsequent to creping the cellulose-based substrate from the first surface, and prior to recreping the cellulose-based substrate from the second surface.

20. The method of claim 17, comprising the step of coating the cellulose-based substrate with the dielectric material subsequent to recreping the cellulose-based substrate from the second surface.

21. The method of claim 17, further comprising the step of applying a latex binder to the cellulose-based substrate subsequent to creping the cellulose-based substrate from the first surface, and prior to recreping the cellulose-based substrate from the second surface.

22. The method of claim 17, further comprising the step of applying a latex binder to the cellulose-based substrate subsequent to recreping the cellulose-based substrate from the second surface.

23. The method of claim 17, further comprising the step of embossing the cellulose-based substrate.
